(19) United States
(12) Patent Application Publication
(10) Pub. No.: US 2024/0201339 A1
(43) Pub. Date: Jun. 20, 2024

(54) Time Multiplexing Flash Light Detection and Ranging Apparatus and Operating Method Thereof

(71) Applicant: Compertum Microsystems Inc., Hsinchu City (TW)

(72) Inventor: Francis Piu MAN, Hsinchu City (TW)

(73) Assignee: Compertum Microsystems Inc., Hsinchu City (TW)

(21) Appl. No.: 18/084,562

(22) Filed: Dec. 20, 2022

(51) Int. Cl. G01S 7/481; G01S 7/484; G01S 7/4861; G01S 17/42

(52) U.S. Cl. CPC G01S 7/4817; G01S 7/484; G01S 7/4861; G01S 17/42

(57) ABSTRACT

A time multiplexing flash light detection and ranging apparatus includes a light transmitter configured to emit pulse light, a beam steering unit optically coupled to the light transmitter and including a plurality of beam steering components, and a light receiver optically coupled to the light transmitter and configured to capture a portion of reflected pulse light from one of the plurality of field of view at a time. The plurality of beam steering components are activated sequentially to multiplex the reflected pulse light from a plurality of field of views, and the reflected pulse light represents the pulse light reflected by at least one object.

### BACKGROUND OF THE INVENTION

### 1. Field of the Invention

The present invention relates generally to systems and methods that use time multiplexing device on Light Detection and Ranging (LiDAR) that use steering mirror for surveying a surrounding environment, and more particularly to systems and methods that use Micro-Electro-Mechanical Systems (MEMS) micro-mirror as time multiplexing device with flash LiDAR for obstacle detection and avoidance in a surrounding environment.

### 2. Description of the Prior Art

With the advent of Autonomous Driving Assist System (ADAS), automobiles demand systems capable of reliably sensing and identifying objects, hazards, and obstacles in navigation. Among all the systems, a Light Detection and Ranging (LiDAR) system measures distances to objects by emitting non-visible laser to objects within the Field of View (FOV) and receiving returned laser signal such that distances to objects are computed by measuring time delay between emitted and returned laser.

Among all specifications, spatial angle resolution is critical in LiDAR design. There is still room for improvement when it comes to LiDAR design.

### SUMMARY OF THE INVENTION

It is therefore a primary objective of the present invention to disclose a time multiplexing flash LiDAR system and method that comprises a plurality of light transmitters, a plurality of time multiplexing opto-mechanical beam steering components and a plurality of Geiger mode avalanche photodiodes that generates high spatial angle resolutions within field of view where a plurality of time multiplexing opto-mechanical beam steering component could be an array of MEMS micro-mirror.

An embodiment of the present invention provides a time multiplexing flash light detection and ranging (LiDAR) apparatus, comprising a light transmitter, configured to emit pulse light; a beam steering unit, optically coupled to the light transmitter and comprising a plurality of beam steering components; and a light receiver, optically coupled to the light transmitter and configured to capture a portion of the reflected pulse light from one of the plurality of FOVs at a time. The plurality of beam steering components are activated sequentially to multiplex reflected pulse light from a plurality of field of views (FOV), and the reflected pulse light represents the pulse light reflected by at least one object.

Another embodiment of the present invention provides a light detection and ranging (LiDAR) operating method, for a time multiplexing flash LiDAR, comprising emitting pulse light from a light transmitter of the time multiplexing flash LiDAR; activating a plurality of beam steering components of a beam steering unit of the time multiplexing flash LiDAR sequentially to multiplexing reflected pulse light from a plurality of field of views (FOV); and by a light receiver of the time multiplexing flash LiDAR, capturing the reflected pulse light from one of the plurality of FOVs at a time. The reflected pulse light represents the pulse light reflected by at least one object

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a LiDAR apparatus according to an embodiment of the present invention.

FIGS. 2 and 3 are schematic diagrams of a time-multiplexing flash LiDAR apparatus according to an embodiment of the present invention.

FIGS. 4 and 5 are schematic diagrams of another time-multiplexing flash LiDAR apparatus according to another embodiment of the present invention.

FIG. 6 is a schematic diagram of a time multiplexing beam steering unit according to an embodiment of the present invention.

FIGS. 7 and 8 show a one-axis activation of a beam steering component according to an embodiment of the present invention.

FIGS. 9 and 10 show beam re-direction by activation of a beam steering component.

FIG. 11 is a schematic diagram of an electro-optical device according to an embodiment of the present invention.

FIG. 12 is a schematic diagram of a LiDAR system according to an embodiment of the present invention.

### DETAILED DESCRIPTION

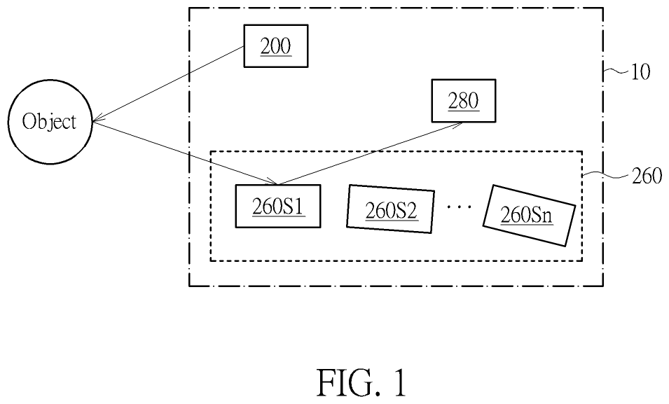

FIG. 1 is a schematic diagram of a LiDAR apparatus 10 according to an embodiment of the present invention. The LiDAR apparatus 10, which may be a flash LiDAR or a time multiplexing flash LiDAR, may include a light transmitter 200 configured to emit pulse light, a beam steering unit 260, and a light receiver 280.

The LiDAR apparatus 10 measures distances to object(s) by emitting at least a non-visible laser pulse or flash at the same time to object(s) in the surrounding environment, and receiving at least a returned pulse signal reflected from the object(s) by the light receiver 280. The pulse light emitted and the reflected pulse light may be non-coaxial, but is not limited thereto. Distances to object(s) are computed using time of flight method by measuring time delay between the pulse light and the reflected pulse light. The LiDAR apparatus 10 may provide a three-dimensional representation of object(s) known as point cloud data which is formed by collecting distance-to-object-data in a two-dimensional space.

A flash LiDAR is desirable because it does not require mechanical parts. However, the spatial resolution of a flash LiDAR is not high since its spatial resolution is determined by the number of light detectors within the flash LiDAR. On the other hand, the LiDAR apparatus 10 may obtain high spatial resolution point cloud data as beam steering components 260S1-260Sn of the beam steering unit 260 are activated sequentially to multiplex the reflected pulse light from different field of views (FOVs). The light receiver 280 may capture the reflected pulse light from one FOV at a time. In a manner of multiplexing, the LiDAR apparatus 10 may generate point cloud data with high spatial resolution.

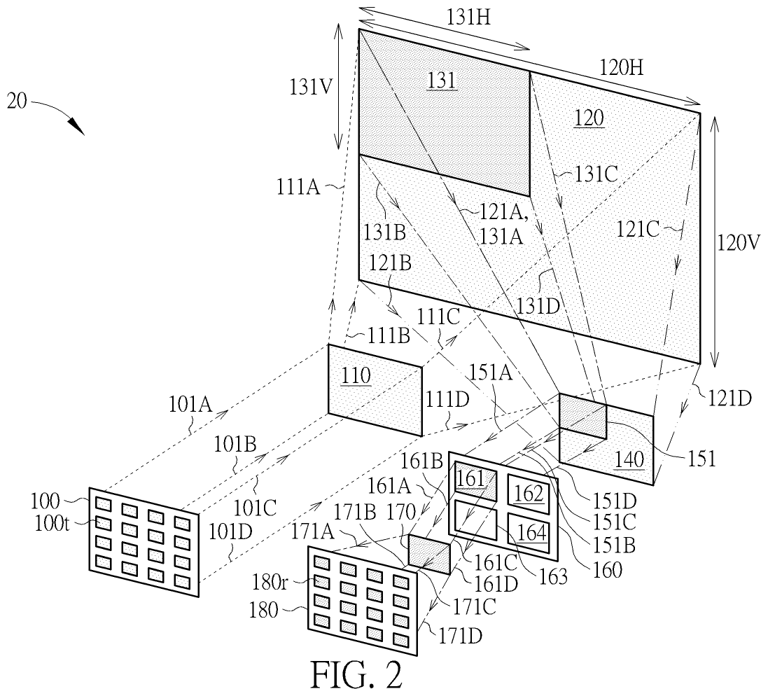

FIG. 2 is a schematic diagram of a time-multiplexing flash LiDAR apparatus 20 according to an embodiment of the present invention, which may include a light transmitter 100, a transmitter deflector 110, a receiver deflector 140, a time multiplexing beam steering unit 160, an intermediate deflector 170, and a light receiver 180. The light transmitter 100, the transmitter deflector 110, the receiver deflector 140, the beam steering unit 160, the intermediate deflector 170, and the light receiver 180 are disposed corresponding to each other and optically coupled.

The light transmitter 100 includes individual light sources 100t configured to emit pulse light (e.g., pulse light beams 101A, 101B, 101C, and 101D) flashing at the same time within an entirety of field of views. The light sources 100t may be arranged in a two-dimensional array (or a one-dimensional array). For example, the light sources 110t may be arranged in column(s) or row(s). The light source 100t may illuminate homogeneously. The pulse light (beam) may be non-visible. The wavelength of the pulse light (beam) is but not limited to 840 nanometers (nm), 905 nm, 940 nm, 1060 nm, 1330 nm, or 1550 nm. The light transmitter 100 may be an edge emitting laser diode source transmitter, or a vertical cavity surface emitting laser (VCSEL) source transmitter, or a photonic crystal surface emitting laser (PCSEL) source transmitter, but is not limited thereto.

The transmitter deflector 110 is disposed in front of the light transmitter 100 and configured to project the pulse light (e.g., pulse light beams 101A, 101B, 101C, and 101D) to the external environment (and match an FOV 120). The transmitter deflector 110 may increase the FOV of light transmission. The pulse light beams 101A-101D exit the transmitter deflector 110 as pulse light beams 111A, 111B, 111C, and 111D. The angular distributions of the pulse light beams 101A-101D with respect to their optical axis are different from the angular distributions of the pulse light beams 111A-111D. The transmitter deflector 110 may include at least one lens to serve as a (divergent) lens unit. With the transmitter deflector 110, the FOV 120 (a horizontal FOV 120H by a vertical FOV 120V) is increased.

Upon reflected/scattered by object(s) in the FOV 120, the reflected pulse light (e.g., reflected pulse light beams 121A, 121B, 121C, 121D, 131A, 131B, 131C, and 131D) strikes on the receiver deflector 140 which is configured to receive/redirect reflected pulse light within the entire FOV 120. The receiver deflector 140 disposed in front of the time multiplexing beam steering unit 160 may increase the FOV of light reception. The receiver deflector 140 may include at least one lens to serve as a (convergent) lens unit. In the LiDAR apparatus 20, the emitted pulse light (e.g., the pulse light beams 111A-111D) and the reflected pulse light (e.g., the reflected pulse light beams 121A-121D) are non-coaxial.

The time multiplexing beam steering unit 160 includes beam steering components 161, 162, 163, and 164 arranged in a two-dimensional array (or a one-dimensional array). The beam steering components 161-164 may have similar structure/elements/material/function. A beam steering component (e.g., the beam steering component 161) is configured to steer a portion of the reflected pulse light (e.g., reflected pulse light beams 151A, 151B, 151C, and 151D) within an FOV 131 from a part (e.g., the part 151) of the receiver deflector 140 to the intermediate deflector 170. The reflected pulse light beams 151A-151D comes from the reflected pulse light beams 131A-131D which corresponds to the FOV 131 (a horizontal FOV 131H by a vertical FOV 131V) out of the FOV 120. The reflected pulse light beams 151A-151D undergo reflection/refraction to exit the beam steering component 161 as reflected pulse light beams 161A, 161B, 161C, and 161D.

The intermediate deflector 170 is disposed between the time multiplexing beam steering unit 160 and the light receiver 180. The reflected pulse light beams 161A-161D bend toward the light receiver 180 by the intermediate deflector 170 as reflected pulse light beams 171A, 171B, 171C, and 171D. The intermediate deflector 170 may include at least one lens to serve as a (convergent) lens unit.

The light receiver 180 is configured to capture the reflected pulse light (e.g., the reflected pulse light beams 171A-171D). The reflected pulse light from one of the beam steering components 161-164 is all imaged onto the light receiver 180. The time delay(s) between the pulse light emitted from the light transmitter 100 and the reflected pulse light received by the light receiver 180 is/are calculated for the light detectors 180r, respectively, to measure the distance(s) between the LiDAR apparatus 20 and the object(s). The light receiver 180 may be a Geiger mode avalanche photodiode receiver including individual light detectors 180r (e.g., Geiger mode avalanche photodiodes). A Geiger mode avalanche photodiode may be/include a silicon based single photon avalanche diode (SPAD), a silicon photomultiplier, a Germanium-on-silicon SPAD, or an InGaAs/InP SPAD. The light detectors 180r may be arranged in a two-dimensional array or a one-dimensional array (such as a row or column) and can be individually configured such that each light detector 180r collects the reflected pulse light beams reflected/scattered by object(s) in an array, in a column, or in a row.

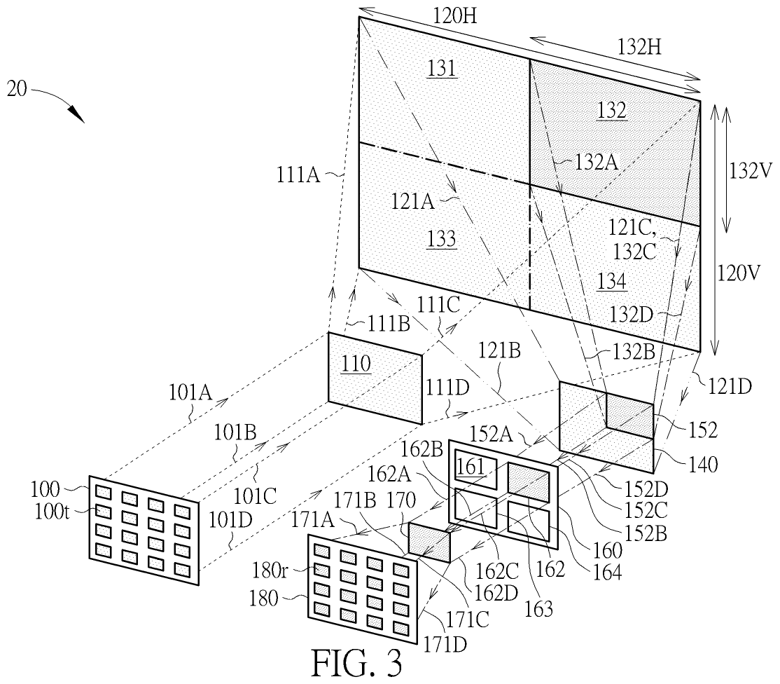

Together FIG. 2 and FIG. 3 show the multiplexing operation of the time multiplexing flash LiDAR apparatus 20 according to an embodiment of the present invention. The FOV 120 may be divided into the FOV 131-134. The time multiplexing beam steering unit 160 activates individual beam steering component (e.g., one of the beam steering components 161-164) sequentially to achieve time multiplexing, which divides a period into time slots and allocates the time slots to the beam steering components 161-164 corresponding to the (partial) FOV 131-134.

For example, FIG. 2 shows optical light paths of the LiDAR apparatus 20 in a first time slot where only the beam steering component 161 turns on. The light transmitter 100 illuminates with the pulse light (e.g., the pulse light beams 101A-101D) emitted simultaneously. Within the FOV 120, the reflected pulse light (e.g., the reflected pulse light beams 121A-121D corresponding to the pulse light beams 101A-101D) are reflected by the object(s), and a portion of the reflected pulse light (e.g., the reflected pulse light beams 131A-131D) is incident on the part 151 of the receiver deflector 140. As shown in FIG. 2, since only the beam steering component 161 is activated during the first time slot, only the portion of the reflected pulse light within the FOV 131 out of the entire FOV 120 (e.g., the reflected pulse light beams 131A-131D) is directed to the intermediate deflector 170 through activated beam steering component 161. Finally, the intermediate deflector 170 directs all the reflected pulse light from the beam steering component 161 (e.g., the reflected pulse light beams 171A-171D) to the light receiver 180 which captures a first point cloud data corresponding to the FOV 131 within the first time slot.

Similarly, when the beam steering component 162 is activated during a second time slot as shown in FIG. 3, only a portion of the reflected pulse light within the FOV 132 out of the entire FOV 120 (e.g., the reflected pulse light beams 132A-132D) is directed to the intermediate deflector 170 through activated beam steering component 162. Reflected pulse light beams 152A-152D undergo reflection/refraction to exit the beam steering component 162 as reflected pulse light beams 162A-162D. The intermediate deflector 170 directs all the reflected pulse light from the beam steering component 162 (e.g., the reflected pulse light beams 171A-171D) to the light receiver 180 which captures a second point cloud data corresponding to the FOV 132 within the second time slot.

Similarly, when the beam steering component 163 is activated during a third time slot, only a portion of the reflected pulse light within the FOV 133 out of the entire FOV 120 is directed to the intermediate deflector 170 through activated beam steering component 163. The intermediate deflector 170 directs all the reflected pulse light from the beam steering component 163 to the light receiver 180 which captures a third point cloud data corresponding to the FOV 133 within the third time slot.

Similarly, when the beam steering component 164 is activated during a fourth time slot, only a portion of the reflected pulse light within the FOV 134 out of the entire FOV 120 is directed to the intermediate deflector 170 through activated beam steering component 164. The intermediate deflector 170 directs all the reflected pulse light from the beam steering component 164 to the light receiver 180 which captures a fourth point cloud data corresponding to the FOV 134 within the fourth time slot.

All the point cloud data (i.e., the first to fourth point cloud data) collected by the light receiver 180 over the period (e.g., at least part of the length of time for the time multiplexing beam steering unit 160 to go through one cycle) may be processed. By integrating all the point cloud data within all the time slots (i.e., the period), an entirety of point cloud data is formed which correspond to the entirety of FOV (i.e., the FOV 120) to present one image for a scene. The time multiplexing flash LiDAR apparatus 20, which may be served as the LiDAR apparatus 10, periodically alternates between the reflected pulse light from different FOVs 131-134 to achieve time multiplexing of the reflected pulse light from different FOVs 131-134. Such time multiplexing of collecting point cloud data increases spatially resolution within the entirety of FOV.

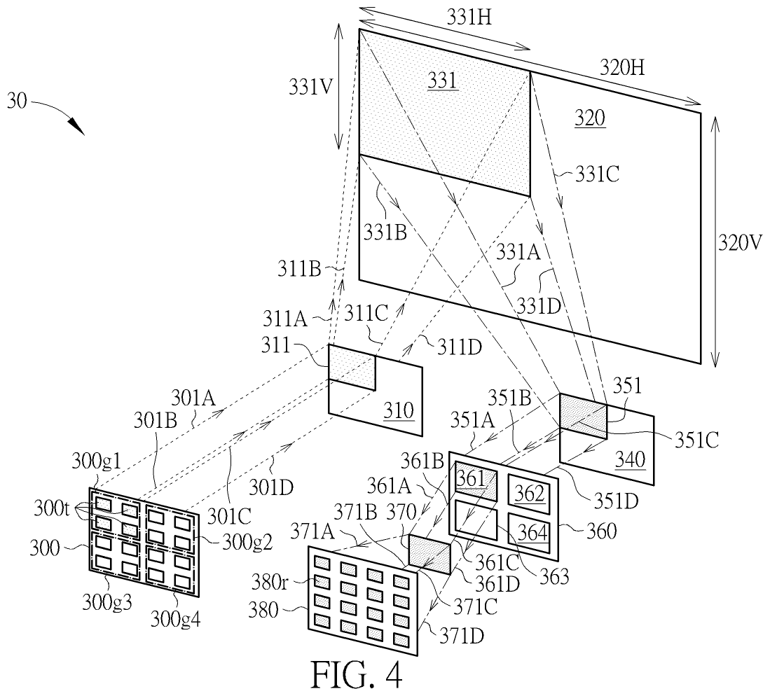

FIG. 4 is a schematic diagram of another time-multiplexing Flash LiDAR apparatus 30 according to an embodiment of the present invention, which may include a light transmitter 300, a transmitter deflector 310, a receiver deflector 340, a time multiplexing beam steering unit 360, an intermediate deflector 370, and a light receiver 380. The LiDAR apparatus 20 and 30 may have similar structure/elements/material/function but perform different multiplexing operations.

The light transmitter 300 includes individual light sources 300t in a two-dimensional array (or a one-dimensional array). The light sources 300t divided into groups 300g1, 300g2, 300g3, and 300g4 may be individually activated or able to be individually activated such that the light sources 300t of the groups 300g1-300g4 illuminate in sequence (i.e., scan-flashing). For example, instead of flashing all the groups 300g1-300g4 at the same time, the light sources 300t in the group 300g1 emit pulse light (e.g., pulse light beams 301A, 301B, 301C, and 301D) flashing at a first time slot.

The pulse light (e.g., the pulse light beams 301A-301D) passes through only a part 311 of the transmitter deflector 310 and leaves the transmitter deflector 110 as pulse light beams 311A, 311B, 311C, and 311D to project an FOV 330 (a horizontal FOV 330H by a vertical FOV 330V) which is a portion of entire FOV 320 (a horizontal FOV 320H by a vertical FOV 320V). Upon reflected by object(s) in the FOV 330, the reflected pulse light (e.g., reflected pulse light beams 331A, 331B, 331C, and 331D) reaches a part 351 of the receiver deflector 350. In the LiDAR apparatus 30, the emitted pulse light (e.g., the pulse light beams 311A-311D) and the reflected pulse light (e.g., the reflected pulse light beams 331A-331D) are non-coaxial.

The time multiplexing beam steering unit 360 includes beam steering components 361, 362, 363, and 364. The beam steering components 361-364 may be arranged in a (two-dimensional or one-dimensional) array similar to or coincide/correspond with another array in which the groups 300g1-300g4 are arranged. A beam steering component (e.g., the beam steering component 361) is configured to steer the reflected pulse light (e.g., reflected pulse light beams 351A, 351B, 351C, and 351D) from a part (e.g., the part 351) of the receiver deflector 340 to the intermediate deflector 370. The reflected pulse light beams 351A-351D corresponding to the reflected pulse light beams 331A-331D undergo reflection/refraction to exit the beam steering component 361 as reflected pulse light beams 361A, 361B, 361C, and 361D.

The light receiver 380 including individual light detectors 380r collects the reflected pulse light (e.g., reflected pulse light beams 371A, 371B, 371C, and 371D).

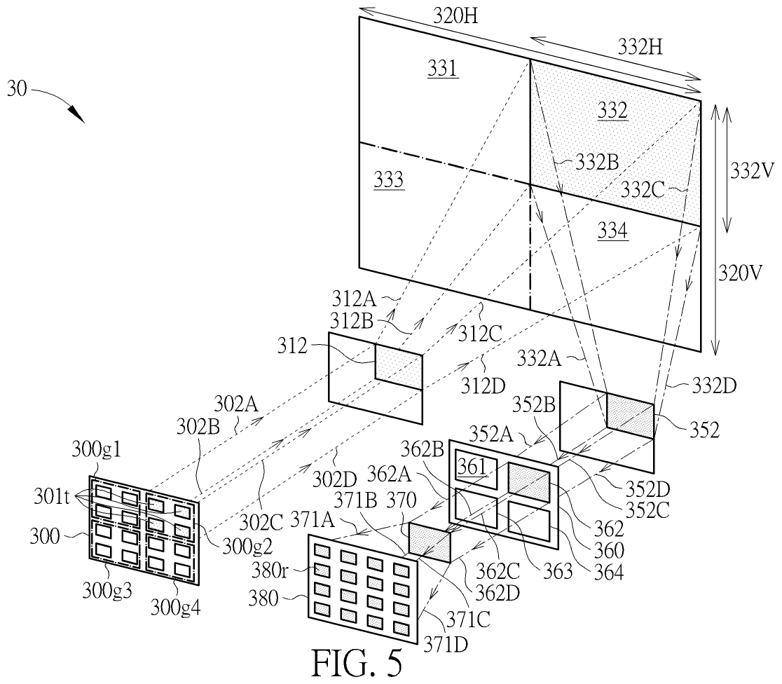

Together FIG. 4 and FIG. 5 show the multiplexing operation of the time multiplexing flash LiDAR apparatus 30 according to an embodiment of the present invention. The light sources 300t in the groups 300g1-300g4 illuminate sequentially as the time multiplexing beam steering unit 360 activates individual beam steering component (e.g., one of the beam steering components 161-164) sequentially to achieve time multiplexing, which divides a period into time slots and allocates the time slots to the beam steering components 361-364.

For example, FIG. 4 shows optical light paths of the LiDAR apparatus 30 in a first time slot where only the light sources 300t of the group 300g1 emit pulse light (e.g., the pulse light beams 301A-301D) flashing at a first time slot. The pulse light (e.g., the pulse light beams 301A-301D) diverges to become the pulse light (e.g., the pulse light beams 311A-311D) projecting the FOV 331. All the reflected pulse light (e.g., the reflected pulse light beams 331A-331D) corresponding to the pulse light (e.g., the pulse light beams 311A-311D) is incident on the part 351 of the receiver deflector 340. As shown in FIG. 4, only the beam steering component 361 is activated during the first time slot, such that the reflected pulse light within the FOV 331 out of the entire FOV 320 (e.g., the reflected pulse light beams 331A-331D) is directed to the intermediate deflector 370 through activated beam steering component 361, and eventually captured by the receiver unit 380 to generate a first point cloud data corresponding to the FOV 331 within the first time slot.

Similarly, only the light sources 300t of the group 300g2 emit pulse light (e.g., the pulse light beams 302A-302D) flashing at a second time slot as shown in FIG. 5. The pulse light (e.g., the pulse light beams 302A-302D) diverges to become the pulse light (e.g., the pulse light beams 312A-312D) projecting the FOV 332. As shown in FIG. 5, only the beam steering component 362 is activated during the second time slot, such that the reflected pulse light within the FOV 332 out of the entire FOV 320 (e.g., the reflected pulse light beams 332A-332D) is directed to the intermediate deflector 370 through activated beam steering component 362, and eventually captured by the receiver unit 380 to generate a second point cloud data corresponding to the FOV 332 within the second time slot.

Similarly, when the light sources 300t of the group 300g3 flashes at a third time slot, only the beam steering component 363 is activated during the third time slot, such that the reflected pulse light within the FOV 333 out of the entire FOV 320 is directed to the intermediate deflector 370 through activated beam steering component 363, and eventually captured by the receiver unit 380 to generate a third point cloud data corresponding to the FOV 333 within the third time slot.

Similarly, when the light sources 300t of the group 300g4 flashes at a fourth time slot, only the beam steering component 364 is activated during the fourth time slot, such that the reflected pulse light within the FOV 334 out of the entire FOV 320 is directed to the intermediate deflector 370 through activated beam steering component 364, and eventually captured by the receiver unit 380 to generate a fourth point cloud data corresponding to the FOV 334 within the fourth time slot.

The last step is to convert all the point cloud data (i.e., the first to fourth point cloud data) within all the time slots (i.e., the period) into an entirety of point cloud data which correspond to the entirety of FOV (i.e., the FOV 320). The time multiplexing flash LiDAR apparatus 30, which may be served as the LiDAR apparatus 10, periodically alternates between the light source 300t of different groups 300g1-300g4 to achieve time multiplexing of the reflected pulse light from different FOVs 331-334. Such time multiplexing of collecting point cloud data increases spatially resolutions within the entirety of FOV. The advantage of this embodiment is the individual addressable light sources 300t at different time slots. Since only a portion of pulse light is emitted from the light transmitter 300, it consumes less optical power. In another aspect, given maximum permissible power limit for eye safety, higher optical power of each light source 300t is allowed and thus possible detection range is longer.

Without the beam steering unit 260/160/360, the spatial resolution is determined by the FOV over the number of Geiger mode avalanche photodiode pixels of a light receiver of a LiDAR apparatus. For example, the entire FOV of the LiDAR apparatus 10/20/30 may be 120 degrees (horizontal) (as shown by the horizontal FOV 120H/320H)×30 degrees (vertical) (as shown by the vertical FOV 120V/320V) with the beam steering unit 260/160/360. Without the beam steering unit 260/160/360, if the entire FOV of a LiDAR apparatus is 120 degrees (horizontal)×30 degrees (vertical) and there are 192 (or M)×56 (or N) pixels of (Geiger mode avalanche photodiode) light detectors, the resolution is 0.625 degrees (horizontal) and 0.536 degrees (vertical).

In an embodiment, the transmitter deflector 310 and the receiver deflector 340 may be integrated, such that the pulse light emitted and the reflected pulse light may be coaxial to achieve coaxial configuration.

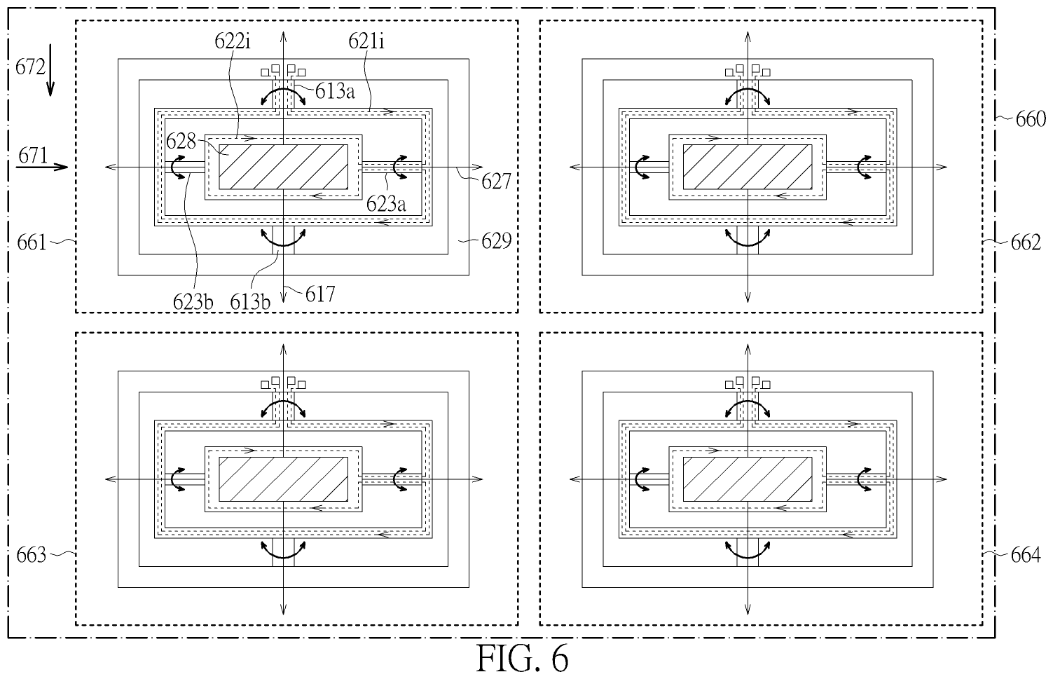

FIG. 6 is a schematic diagram of a time multiplexing beam steering unit 660 according to an embodiment of the present invention. The time multiplexing beam steering unit 660, which may be served as the time multiplexing beam steering unit 160/260/360, may include beam steering components 661, 662, 663, and 664 arranged in a two-dimensional array (or a one-dimensional array). Each of the beam steering components 661-664 may be a two-dimensional MEMS micro-mirror device including flexures 613a, 613b, 623a, 623b, a reflective mirror surface 628, and a substrate 629. The four substrates 629 may merge into one substrate.

Each beam steering component may be an electromagnetic driven beam steering mirror. Take the beam steering component 661 as an example. In response to a current 621i, the flexures 613a-613b may rotate around another axis 617. Under a magnetic field 672 and in response to a current 622i, the flexures 623a-623b together with the reflective mirror surface 628 may rotate around an axis 627, which is orthogonal to the axis 617. Similarly, under the magnetic field 671 ad in response to a current 621i, the flexures 613a-613b together with the reflective mirror surface 628 may rotate around the axis 617. That is, the beam steering component 661 is able to redirect the reflected pulse light (e.g., the reflected pulse light beams 151A-154D or 351A-354D) toward the intermediate deflector 170/370 when the beam steering component 661 is activated (during the first time slot). The beam steering component 661 may bend the reflected pulse light (e.g., the reflected pulse light beams 151A-154D or 351A-354D) away from the intermediate deflector 170/370 (and the light receiver 180/380) when the beam steering component 661 is turned off (during the second, third, and fourth time slots).

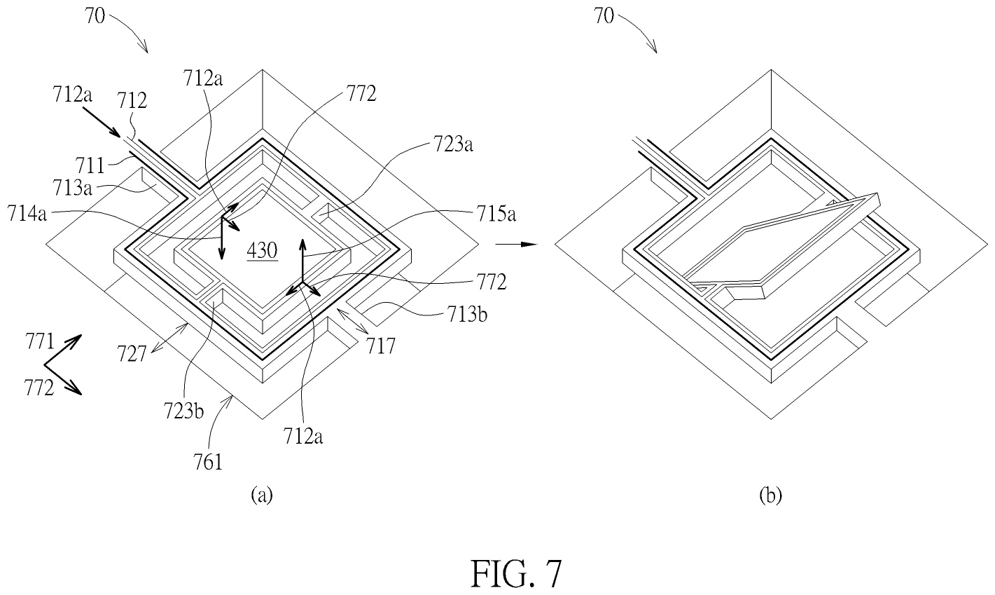

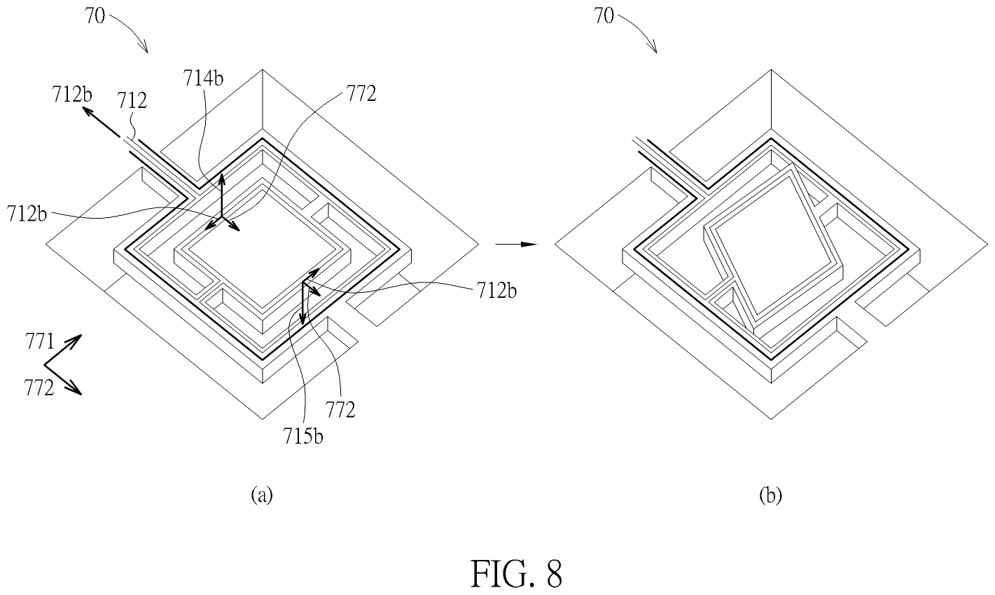

FIGS. 7 and 8 show a one-axis activation of a beam steering component 70 according to an embodiment of the present invention. The beam steering component 70 may be served as any of the beam steering components 260S1-260Sn, 161-164, or 361-364. The beam steering component 70 may be a two-dimensional electromagnetic-driven MEMS micro-mirror. Under a magnetic field 772 (as show in (a) of FIG. 7), when a direct current (DC) current 712a is applied to a coil 712 that resides around a mirror 430, Lorentz forces 714a and 715a, which are equal in magnitude but opposite in direction, are generated out of the plane (parallel to the mirror 430) causing the mirror 430 and flexure 723a, 723b to rotate anti-clockwise around an axis 727. Eventually, the mirror 430 stops at an angle as the Lorentz forces (714a, 715a) are counter-balanced by the torsional forces of the flexure 723a and 723b (as show in (b) of FIG. 7). On the contrary, under a magnetic field 771 (as show in (a) of FIG. 8), when a DC current 711b is applied to a coil 711, Lorentz forces 714b and 715b, which are equal in magnitude but opposite in direction, are generated out of the plane causing the mirror 430 and flexure 723a, 723b to rotate clockwise around the axis 727. Eventually, the mirror surface 430 stops at an angle as the Lorentz forces (714b, 715b) are counter-balanced by the torsional forces of the flexure 723a and 723b (as show in (b) of FIG. 8).

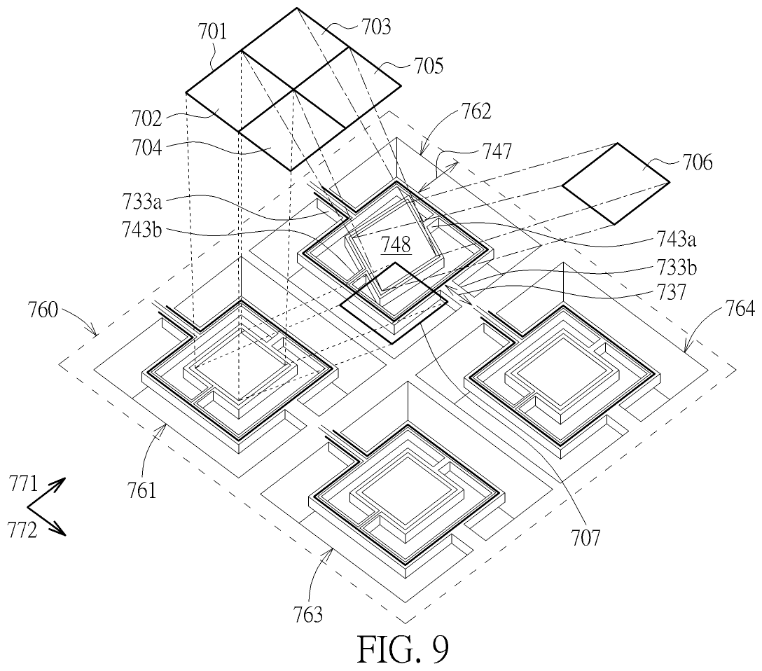

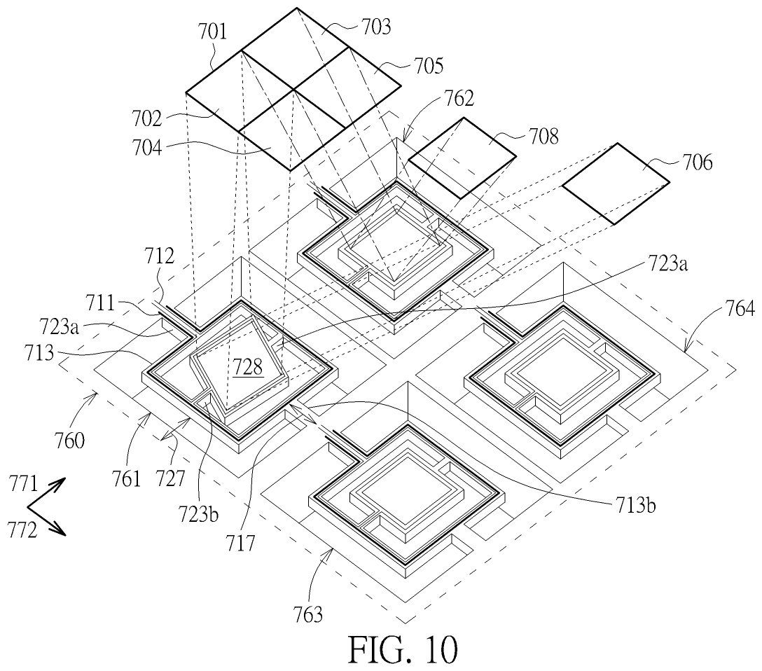

FIGS. 9 and 10 show beam re-direction by activation (turning on) of an (electromagnetic driven) beam steering component. A time multiplexing beam steering unit 760, which may be served as the time multiplexing beam steering unit 160/260/360, may include beam steering components 761, 762, 763, and 764. When the beam steering component 761 (i.e., one of the beam steering components 760) is in off-state (as shown in FIG. 9) in a first time slot, no corresponding DC current is applied to the beam steering component 761 such that the beam steering component 761 directs reflected pulse light that associates with a FOV 702 to an arbitrary area 707. A mirror 728 of the beam steering component 761 in off-state may be parallel to the main surface of the time multiplexing beam steering unit 760. In the next time slot, the beam steering component 761 is activated to on-state (as shown in FIG. 10), it directs the reflected pulse light that associates with the FOV 702 to an intermediate deflector 706. The mirror 728 of the beam steering component 761 in on-state may be tilted with respect to the main surface of the time multiplexing beam steering unit 760.

However, when the beam steering component 762 is in on-state (as shown in FIG. 9) in the first time slot, a corresponding DC current is applied such that the beam steering component 762 directs reflect pulse light that associates with a FOV 703 to the intermediate deflector 706. In the next time slot, the beam steering component 762 is deactivated to off-state (as shown in FIG. 10), it directs the reflected pulse light that associated with the FOV 703 back to an arbitrary area 708. In an embodiment, the mirror 748 of the beam steering component 762 in off-state may be parallel to the main surface of the time multiplexing beam steering unit 760. The mirror 748 of the beam steering component 762 in off-state may be parallel or nonparallel to the mirror 728 of the beam steering component 761 in off-state.

A beam steering component may not be limited to a two-axis MEMS micro-mirror device. Each beam steering component in a time multiplexing beam steering unit may include a (one-axis or two-axis) MEMS micro-mirror, or a MEMS based resonant mirror, which may be driven by electrostatic mechanism, electromagnetic mechanism, thermal mechanism, or piezoelectric mechanism, a mechanical driven mirror, a mechanical driven prism, or a lens. The mechanical driven mirror may be a polygon mirror. The mechanical driven prism may be a Risley prism. Each beam steering component may be opto-mechanical. For example, a beam steering component may include the flexures 613a-623b and the substrate 629, while a lens for the beam steering component may replace the reflective mirror surface 628.

A time multiplexing beam steering unit may include four beam steering components but is not limited thereto. In fact, a time multiplexing beam steering unit may include N beam steering components, where N is an integer greater than 1.

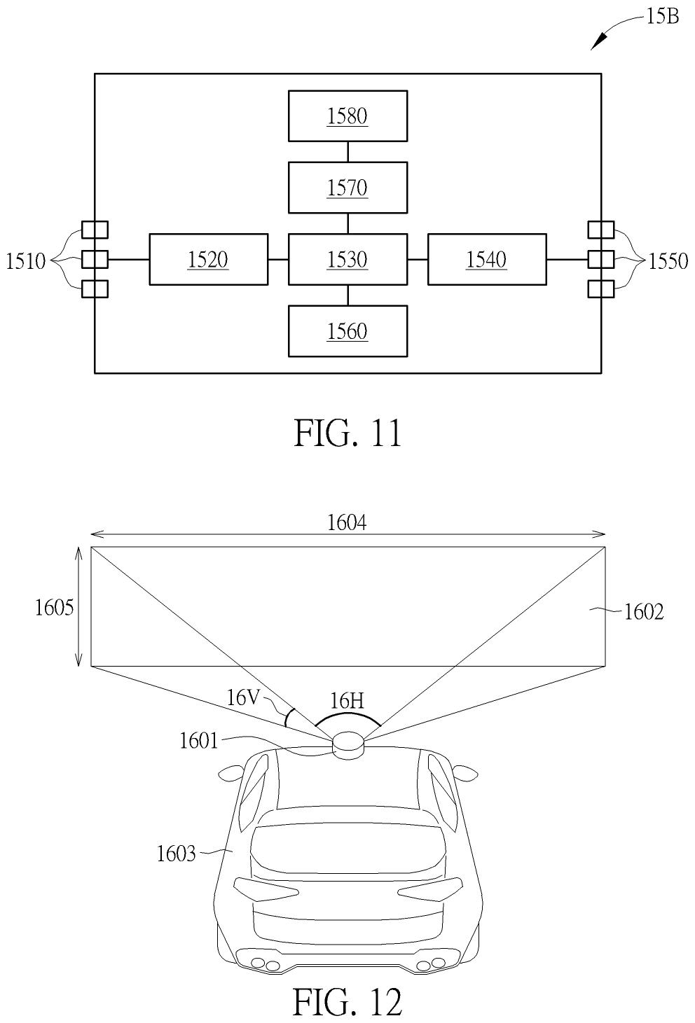

FIG. 11 is a schematic diagram of an electro-optical device 15B according to an embodiment of the present invention. The electro-optical device 15B includes ingress ports 1510 and at least one transmitting unit (Tx) 1520, a central processing unit 1530, at least one receiving unit (Rx) 1540, egress ports 1550, a memory unit 1560, a MEMS control unit 1570, and a MEMS apparatus 1580.

The central processing unit 1530 processes data implementing by one or more computer chip(s) such as field programmable gate arrays (FPGAs), application specific integrated circuits (ASICs), digital signal processors (DSPs). The processing unit 1530 inputs data or control signals from the ingress ports 1510 through the egress ports 1550. The processing unit 1530 also stores and retrieves data, or program to and from the memory unit 1560. The memory unit 1560 may be in form of tape drives, solid state drives, or flash memory. The memory unit 1560 may be volatile, non-volatile, read-only memory (ROM), random access memory (RAM), ternary content-addressable memory (TCAM), static random-access memory (SRAM) and combination thereof. The processing unit 1530 also exports data to egress ports 1550 through transmitting unit 1540. The processing unit 1530 communicates with the MEMS control unit 1570 which in turns controls the MEMS apparatus 1580, which may be served as the time multiplexing beam steering unit 160/260/360/660.

FIG. 12 is a schematic diagram of a LiDAR system according to an embodiment of the present invention. A LiDAR apparatus 1601 may be mountable on a vehicle 1603 to scan environment 1602 around a vehicle 1603. The LiDAR apparatus 1601 may be attached or mounted to any part of the vehicle 1603.

The LiDAR apparatus 1601 may coordinate operation of a light transmitter or a light receiver with the movement of a beam steering unit in two axes (e.g., a horizontal axis 1604 and a vertical axis 1605) in order to rotate or stop at a fixed angle. The beam steering unit may direct light projected towards the FOVs 16H and 16V. The light receiver may receive light reflected from the surroundings of the vehicle 1603 in the FOVs 16H and 16V and transfer reflection signals indicative of light reflected from object(s) in the FOVs 16H and 16V to a central processing unit.

To sum up, a time multiplexing beam steering unit of the invention selects a portion of the entire FOV to be focused onto a light receiver by activating one/some of its beam steering component(s) and inactivating the other beam steering component(s) so as to collect point cloud data corresponding to the portion of the entire FOV in a time slot. The point cloud data collected over all the time slots is converted into an entirety of point cloud data corresponding to the entire FOV. Such time multiplexing of collecting point cloud data increases spatially resolutions within the entirety of field of view.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A time multiplexing flash light detection and ranging (LiDAR) apparatus, comprising:
a light transmitter, configured to emit pulse light;
a beam steering unit, optically coupled to the light transmitter and comprising a plurality of beam steering components, wherein the plurality of beam steering components are activated sequentially to multiplex reflected pulse light from a plurality of field of views (FOV), and the reflected pulse light represents the pulse light reflected by at least one object; and
a light receiver, optically coupled to the light transmitter and configured to capture a portion of the reflected pulse light from one of the plurality of FOVs at a time.

2. The time multiplexing flash LiDAR apparatus of claim 1, wherein at least a first beam steering component of the plurality of beam steering components is configured to steer the reflected pulse light within a first FOV of the plurality of FOVs toward the light receiver at a first time slot, the time multiplexing flash LiDAR apparatus generates a first point cloud data corresponding to the first FOV at the first time slot, at least a second beam steering component of the plurality of beam steering components is configured to steer the reflected pulse light within a second FOV of the plurality of FOVs toward the light receiver at a second time slot, and the time multiplexing flash LiDAR apparatus generates a second point cloud data corresponding to the second FOV at the second time slot.

3. The time multiplexing flash LiDAR apparatus of claim 1, wherein an entirety of point cloud data corresponding to an entirety of the plurality of FOVs is formed by integrating at least a plurality of point cloud data corresponding to the plurality of FOV at a plurality of time slots.

4. The time multiplexing flash LiDAR apparatus of claim 1, wherein the light transmitter comprises a plurality of light sources, and all the plurality of light sources emit the pulse light flashing simultaneously within an entirety of the plurality of FOVs.

5. The time multiplexing flash LiDAR apparatus of claim 1, wherein the light transmitter comprises a plurality of light sources, the plurality of light sources are divided into a plurality of groups, each of the plurality of groups is corresponding to one of the plurality of FOVs, and the plurality of groups are activated sequentially to emit the pulse light according to how the plurality of beam steering components are activated.

6. The time multiplexing flash LiDAR apparatus of claim 1, wherein the light transmitter comprises a plurality of light sources, the plurality of light sources are divided into a plurality of groups, a first group of the plurality of groups is configured to emit the pulse light flashing at a first time slot within one of the plurality of FOVs, and a second group of the plurality of groups is configured to emit the pulse light flashing at a second time slot within another of the plurality of FOVs.

7. The time multiplexing flash LiDAR apparatus of claim 1, wherein the light transmitter comprises a plurality of light sources, the plurality of light sources are divided into a plurality of groups, the plurality of groups are arranged in a first array, the plurality of beam steering components are arranged in a second array, the first array is similar to or coincide with the second array, and the first array and the second array are two-dimensional arrays or one-dimensional arrays.

8. The time multiplexing flash LiDAR apparatus of claim 1, wherein each of the plurality of beam steering components comprises a microelectromechanical systems (MEMS) micro-mirror or a MEMS based resonant mirror driven by electrostatic mechanism, electromagnetic mechanism, thermal mechanism, or piezoelectric mechanism, a mechanical driven mirror, a mechanical driven prism, or a lens, the mechanical driven mirror is a polygon mirror, and the mechanical driven prism is a Risley prism.

9. The time multiplexing flash LiDAR apparatus of claim 1, further comprising:
a transmitter deflector, configured to deflect the pulse light;
a receiver deflector, configured to deflect the reflected pulse light; or
an intermediate deflector, configured to deflect the reflected pulse light.

10. The time multiplexing flash LiDAR apparatus of claim 1, wherein the pulse light incident on the at least one object and the reflected pulse light coming back from the at least one object are non-coaxial.

11. The time multiplexing flash LiDAR apparatus of claim 1, wherein the light transmitter is an edge-emitting laser source transmitter, a vertical cavity surface emitting laser (VCSEL) source transmitter emitting the pulse light, a fiber laser, or a photonic crystal surface emitting laser (PCSEL) source transmitter.

12. The time multiplexing flash LiDAR apparatus of claim 1, wherein the light receiver is a Geiger mode avalanche photodiode receiver comprising a plurality of light detectors.

13. The time multiplexing flash LiDAR apparatus of claim 1, wherein the pulse light is non-visible, and a wavelength of the pulse light is 840 nm, 905 nm, 940 nm, 1330 nm, or 1550 nm.

14. The time multiplexing flash LiDAR apparatus of claim 1, wherein the light transmitter comprises a plurality of light sources, and the plurality of light sources is individually activated, able to be individually activated, or illuminates homogeneously.

15. The time multiplexing flash LiDAR apparatus of claim 1, wherein a distance between the time multiplexing flash LiDAR apparatus and one of the at least one object is calculated by measuring a time delay between the pulse light and the reflected pulse light.

16. The time multiplexing flash LiDAR apparatus of claim 1, wherein the light receiver comprises a plurality of light detectors, the plurality of light detectors are arranged in a two-dimensional array or a one-dimensional array, wherein each of the plurality of light detectors is individually activated, able to be individually activated to receive the reflected pulse light individually or homogeneously.

17. A light detection and ranging (LiDAR) operating method, for a time multiplexing flash LiDAR, comprising:
emitting pulse light from a light transmitter of the time multiplexing flash LiDAR;
activating a plurality of beam steering components of a beam steering unit of the time multiplexing flash LiDAR sequentially to multiplexing reflected pulse light from a plurality of field of views (FOV), wherein the reflected pulse light represents the pulse light reflected by at least one object; and
by a light receiver of the time multiplexing flash LiDAR, capturing the reflected pulse light from one of the plurality of FOVs at a time.
